(19) United States
(12) Patent Application Publication
(10) Pub. No.: US 2020/0263113 A1
(43) Pub. Date: Aug. 20, 2020

(54) Bio Resin Surface Cleaner and Protectant Agent

(71) Applicant: Steven H. Bortz, Westlake Village, CA (US)

(72) Inventor: Steven H. Bortz, Westlake Village, CA (US)

(21) Appl. No.: 16/783,797

(22) Filed: Feb. 6, 2020

Related U.S. Application Data
(60) Provisional application No. 62/807,233, filed on Feb. 18, 2019.
(60) Provisional application No. 62/872,801, filed on Jul. 11, 2019.

(51) Int. Cl. C11D 11/00; C11D 3/38; C11D 17/00; C11D 17/04; C11D 3/37

(52) U.S. Cl. CPC C11D 11/0058; C11D 11/0023; C11D 3/38; C11D 17/0043; C11D 3/3715; C11D 17/049; C11D 3/3749; C11D 3/3726; C11D 17/0008

(57) ABSTRACT

A bio resin agent cleaner and protectant for painted automotive surface finishes, clear coat finishes, fiberglass, chrome, rubber, plastic, gel coat, aluminum, steel, and glass surfaces. In addition to cleaning and protecting the product leaves a semi permanent gloss on most all surfaces. The bio resin agent cleaner and protectant may be a soy bio resin, a grapeseed bio resin, a sunflower bio resin, a vegetable based bio resin, or any equivalent bio resin, for example a soy methyl ester based from soy oil. In one embodiment the bio resin agent cleaner and protectant is a bio resin combined with surfactants and emulsifiers. The bio resin agent addresses the needs for cleaning and protecting painted automotive surfaces.

### CROSS-REFERENCE TO RELATED APPLICATIONS

The present application claims the priority of U.S. Provisional Patent Application Ser. No. 62/807,233 filed Feb. 18, 2019, and U.S. Provisional Patent Application Ser. No. 62/872,801 filed Jul. 11, 2019, which applications are incorporated in its entirety herein by reference.

### BACKGROUND OF THE INVENTION

The present invention relates to protecting surfaces and in particular to bio-resin agent cleaner and protectant for painted and clear coat vehicle bodies.

Car enthusiasts generally value the appearance of their cars and often display them in car shows. These enthusiasts desire to show a bright mirror-like shine. While some products provide such a shine, they do not always provide added protection to the painted surface.

Further, some classic cars are rust prone and the owners are reluctant to use a washing method including spraying their cars with a water hose in preparation for a car show. Unfortunately, known waterless washing systems have damaged paint or other surfaces. As a result, there is a need for a waterless or reduced water car washing system which cleans and protects the painted car body without harming the paint or surfaces, or inducing rust.

### BRIEF SUMMARY OF THE INVENTION

The present invention addresses the above and other needs by providing a bio resin agent cleaner and protectant for painted automotive surface finishes, clear coat finishes, fiberglass, chrome, rubber, plastic, gel coat, aluminum, steel, and glass surfaces. In addition to cleaning and protecting the product leaves a semi permanent gloss on most all surfaces. The bio resin agent cleaner and protectant may be a soy bio resin, a grapeseed bio resin, a sunflower bio resin, a vegetable based bio resin, or any equivalent bio resin, for example a soy methyl ester based from soy oil. In one embodiment the bio resin agent cleaner and protectant is a bio resin combined with surfactants and emulsifiers. The bio resin agent addresses the needs for cleaning and protecting painted automotive surfaces.

In accordance with one aspect of the invention, there is provided a spay bottle cleaner and protectant for painted automotive surface finishes, clear coat finishes, fiberglass, chrome, rubber, plastic, gel coat, aluminum, steel, and glass surfaces. The spray bottle contains a bio resin solution sprayed directly on to a painted car body, followed by wiping with a clean cloth. The bio resin solution includes the bio resin, a surfactant, and emulsifiers.

In accordance with another aspect of the invention, there is provided a cleaning towel which is wetted with a bio resin solution. The bio resin solution includes the bio resin, a surfactant, and emulsifiers. The towel is preferably a low lint fabric sheet, for example a melt-blown polypropylene or polyurethane-coated polyester fabric about 10 inches by 12 inches having an even surface or a dimpled, ridged, or otherwise textured surface. The bio resin may be a soy bio resin, a grapeseed bio resin, a sunflower bio resin, a vegetable based bio resin, or any equivalent bio resin, and is preferably a soy methyl ester based from soy oil. The towel may be used without water to clean a painted surface or unpainted surface, and in particular to clean a car body.

In accordance with yet another aspect of the invention, there is provided a concentrated car body cleaner. The car body cleaner contains a bio resin solution applied directly on to a car body, followed by lightly rinsing the car body to remove excess car body cleaner. The bio resin solution includes the bio resin, a surfactant, and emulsifiers.

In accordance with another aspect of the invention, there is provided a bio resin cleaning and polishing agent. The bio resin cleaning and polishing agent is suitable for use on painted auto surfaces, & chrome, plastic, rubber, gel coat, fiberglass, stainless steel, aluminum, and magnesium.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a side view of a spray bottle containing a bio resin cleaner according to the present invention.

FIG. 2A is a top view of a car washing towel according to the present invention.

FIG. 2B is an edge view of the car washing towel according to the present invention.

FIG. 2C is a side view of the car washing towel according to the present invention.

FIG. 3 is a side view of a bucket containing a bio resin cleaner according to the present invention.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to describe a feature's appearance to the human eye or human perception, and not a precise measurement. Where amounts are presented, they may be within 10% of the amount stated.

The bio resin agent cleaner and protectant of the present invention preferably comprises the following ingredients:

1) preferably between 50 and 90 percent by volume of base deionized water and more preferably between 70 and 90 percent by volume of base deionized water (used as a carrier of other ingredients used to dissolve and or blend with coatings, pastes and other liquid gels);

2) preferably between one and ten percent by volume of bio resin, and more preferably between one and five percent by volume of the bio resin, which cleans and protects paint finishes;

3) preferably between 0.1 and five percent by volume of a surfactant and more preferably 0.1 and 2.5 percent by volume of the surfactant (enables the non water base ingredients to blend and polarize with the water); and

4) preferably between 0.1 and five percent by volume of an emulsifier and more preferably 0.1 and 2.5 percent by volume of the emulsifier (aids the non water base ingredients to blend and polarize with the surfactant and the water).

The bio resin agent cleaner and protectant may be applied using a spray bottle 10, a towel or wipe 20, or as a concentrate added to water in a bucket 30. Those skilled in the art may recognize other avenues for applying the bio resin agent cleaner and protectant to painted surfaces, and those other avenues are intended to come within the scope of the present invention. Bio resin combined with surfactants and emulsifiers is preferred for cleaning, and the bio resin provides a semi permanent shine and protectant.

A preferably bio resin is selected from a soy bio resin, a grapeseed bio resin, a sunflower bio resin, a vegetable based bio resin, or any equivalent bio resin. A more preferred bio resin is a soy methyl ester based from soy oil. The soy methyl ester bio resin penetrates most all surfaces and maintains the semi permanent protective gloss finish. The bio resin agent cleaner and protectant preferably comprises 0.1 to five percent bio resin, 0.1 percent to five percent surfactants, 0.1 to five percent emulsifiers, and 85 to 99.7 percent de ionized water volume, and more preferably comprises, 1.5 to 2.5 percent bio resin, 0.1 percent to five percent surfactants, 0.1 to five percent emulsifiers and 85 to 99.7 percent de ionized water volume.

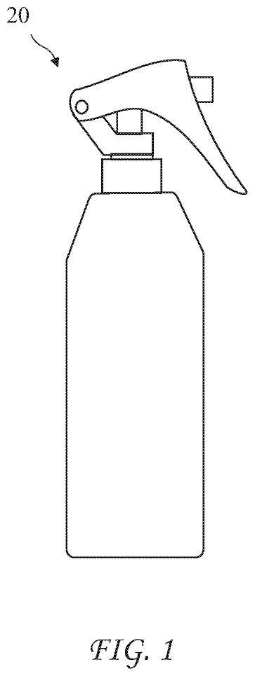

A side view of a spray bottle 10 containing the bio resin agent cleaner and protectant is shown in FIG. 1. By dispersing the bio resin agent cleaner and protectant through a spray bottle, the user avoids the waste of water associated with the conventional water hose, soap and labor to clean a surface. In addition to cleaning, the bio resin agent cleaner and protectant leaves a protective high gloss finish. The bio resin agent cleaner and protectant is applied with a few squirts onto the automobile body surface and then the complete surface is wiped with a soft micro fiber or equal material to a clean result. The bio resin agent cleaner and protectant is preferably a blend of bio resin, surfactants, emulsifiers, and de ionized water.

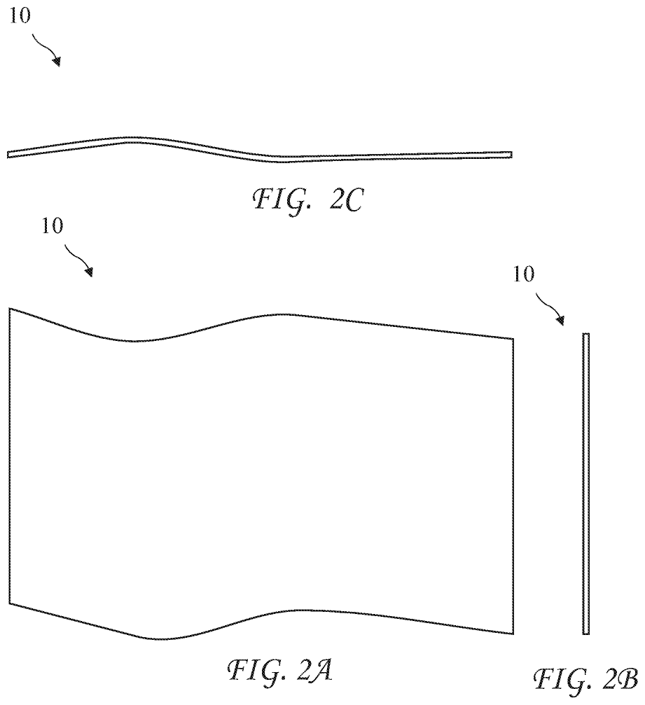

A top view of the towel 20 carrying the bio resin agent cleaner and protectant is shown in FIG. 2A, an end view of the towel 20 is shown in FIG. 2B, and an edge view of the towel 10 is shown in FIG. 2C. In general, the towel may be wetted by between 0.09 and 0.11 (milliliter) of the bio resin agent cleaner and protectant per square inch of the towel. For example, the towel 20 may have a length between 10 to 12 inches and a width between 10 to 12 inches, and preferably is a low lint fabric sheet, for example a melt-blown polypropylene or polyurethane-coated polyester fabric having an even surface or a dimpled, ridged, or otherwise textured surface, wetted with preferably 11 to 13 ml (milliliters) of a bio resin per towel.

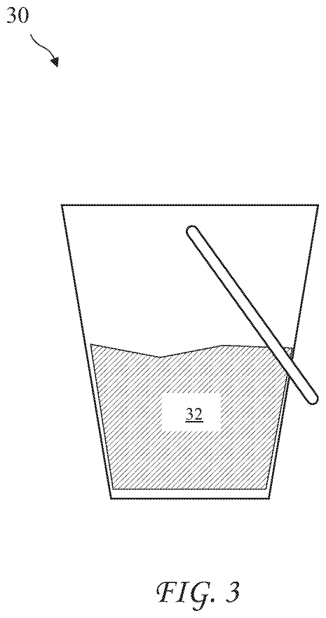

A side view of a bucket 30 containing a bio resin agent cleaner and protectant created by mixing a bio resin cleaning concentrate 32 mixed with water is shown in FIG. 3. The cleaning concentrate 32 and water mixture addresses the needs for cleaning and protecting most all finishes. The bio resin agent cleaner and protectant is produced by mixing between four and six ounces of the bio resin cleaning concentrate 32 with one gallon of water. The bio resin agent cleaner and protectant is applied to a surface followed by rinsing with water. A dry clean chamois or micro fiber towel may be used to dry the surface to produce a high gloss semi permanent protected finish. The cleaning concentrate preferably comprises nine to 15 percent bio resin, two to six percent surfactants, two to six percent emulsifiers, and 73 to 86 percent water by volume, and more preferably comprises 11 to 13 percent bio resin, three to five percent surfactants, three to five percent emulsifiers, and 77 to 83 percent water by volume.

While the invention herein disclosed has been described by means of specific embodiments and applications thereof, numerous modifications and variations could be made thereto by those skilled in the art without departing from the scope of the invention set forth in the claims.

I claim:

1. A surface protectant and cleaner and an avenue for application, comprising:
a bio resin agent cleaner and protectant comprising:
a water;
a bio resin;
a surfactant; and
an emulsifier; and
the avenue for application.

2. The surface protectant and cleaner and avenue for application of claim 1, wherein the bio resin agent cleaner and protectant, comprises:
between 50 and 90 percent by volume of base deionized water;
between one and ten percent by volume of bio resin;
between 0.1 and five percent by volume of a surfactant; and
between 0.1 and five percent by volume of an emulsifier.

3. The surface protectant and cleaner and avenue for application of claim 1, wherein the avenue for application comprises a spray bottle containing the bio resin agent cleaner and protectant.

4. The surface protectant and cleaner and avenue for application of claim 3, wherein the bio resin agent cleaner and protectant, comprises by volume:
85 to 99.7 percent de ionized water;
0.1 to five percent bio resin;
0.1 percent to five percent surfactants; and
0.1 to five percent emulsifiers.

5. The surface protectant and cleaner and avenue for application of claim 3, wherein the bio resin agent cleaner and protectant, comprises by volume:
85 to 99.7 percent de ionized water;
1.5 to 2.5 percent bio resin;
0.1 percent to five percent surfactants; and
0.1 to five percent emulsifiers.

6. The surface protectant and cleaner and avenue for application of claim 1, wherein the avenue for application comprises:
a towel; and
the towel is wetted by between 0.09 and 0/11 (milliliter) of the bio resin agent cleaner and protectant per square inch of the towel.

7. The surface protectant and cleaner and avenue for application of claim 6, wherein the towel has a length between 10 to 12 inches and a width between 10 to 12 inches

8. The surface protectant and cleaner and avenue for application of claim 6, wherein the towel is a low lint fabric sheet.

9. The surface protectant and cleaner and avenue for application of claim 6, wherein the towel material having a textured surface.

10. The surface protectant and cleaner and avenue for application of claim 9, wherein the towel material is selected from the group consisting of a melt-blown polypropylene, and a polyurethane-coated polyester fabric.

11. The surface protectant and cleaner and avenue for application of claim 9, wherein the towel material is a polyurethane-coated polyester fabric having a dimpled or ridged surface.

12. The surface protectant and cleaner and avenue for application of claim 1, wherein the avenue for application comprises a bucket containing the bio resin agent cleaner and protectant concentrate mixed with water.

13. The surface protectant and cleaner and avenue for application of claim 12, wherein between four and six ounces of the bio resin agent cleaner and protectant concentrate is mixed with one gallon of water

14. The surface protectant and cleaner and avenue for application of claim 13, wherein the bio resin agent cleaner and protectant concentrate, comprises by volume:
73 to 86 percent water;
nine to 15 percent bio resin;
two to six percent surfactants; and
two to six percent emulsifiers.

15. The surface protectant and cleaner and avenue for application of claim 13, wherein the bio resin agent cleaner and protectant concentrate, comprises by volume:
77 to 83 percent water;
11 to 13 percent bio resin;
three to five percent surfactants; and
three to five percent emulsifiers.

16. The surface protectant and cleaner and avenue for application of claim 13, wherein between four and six ounces of the bio resin agent cleaner and protectant concentrate is mixed with one gallon of water.

17. A surface protectant and cleaner and an avenue for application, comprising:
a bio resin agent cleaner and protectant comprising:
85 to 99.7 percent de ionized water;
1.5 to 2.5 percent bio resin;
0.1 percent to five percent surfactants; and
0.1 to five percent emulsifiers. and
a spray bottle containing the bio resin agent cleaner and protectant.

18. A surface protectant and cleaner and an avenue for application, comprising:
a bio resin agent cleaner and protectant comprising:
between 50 and 90 percent by volume of base deionized water;
between one and ten percent by volume of bio resin;
between 0.1 and five percent by volume of a surfactant; and
between 0.1 and five percent by volume of an emulsifier;
a wetted towel wetted by between 0.09 and 0/11 (milliliter) of the bio resin agent cleaner and protectant per square inch of the towel, the towel made from a dimpled or ridged surface material selected from the group consisting of: melt-blown polypropylene, a polyurethane-coated polyester fabric, and a polyurethane-coated polyester fabric.
